(19) United States
(12) Patent Application Publication
(10) Pub. No.: US 2005/0285308 A1
(43) Pub. Date: Dec. 29, 2005

(54) Stamper, imprinting method, and method of manufacturing an information recording medium

(75) Inventors: Kazuhiro Hattori, Tokyo (JP); Minoru Fujita, Tokyo (JP); Shuichi Okawa, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/147,259

(22) Filed: Jun. 8, 2005

(30) Foreign Application Priority Data
Jun. 10, 2004 (JP) 2004-172397

(51) Int. Cl. B28B 11/08; B29C 59/00; B30B 12/00; B44C 1/22

(52) U.S. Cl. 264/293; 100/299; 216/52

(57) ABSTRACT

There is provided a stamper for imprinting on which a concave/convex pattern is formed with a plurality of convex parts of different widths protruding from a surface. In the concave/convex pattern, the respective convex parts are formed so that a distance between a top of a convex part and a reference plane defined in a range between the surface and a rear surface of the stamper is longer for convex parts with wide widths than for convex parts with narrow widths. An imprinting method transfers the concave/convex form of the stamper to a resin layer on the surface of a substrate. A method of manufacturing an information recording medium uses the concave/convex form transferred by the imprinting method to manufacture an information recording medium.

### BACKGROUND OF THE INVENTION

1. Field of the Invention

The present invention relates to a stamper for imprinting that is used when manufacturing an information recording medium or the like, an imprinting method that presses a stamper onto a resin layer formed on the surface of a substrate to transfer a concave/convex pattern of the stamper, and a method of manufacturing an information recording medium that manufactures an information recording medium using the concave/convex pattern transferred to the resin layer.

2. Description of the Related Art

Optical lithography is conventionally known as a method of forming a fine concave/convex pattern (a resist pattern) in a resist layer formed on the surface of a substrate as part of a process that manufactures a semiconductor element, an information recording medium, or the like. During optical lithography, light for exposing the resist layer formed on the substrate is irradiated to form an exposure pattern and the resist layer is then developed to form a concave/convex pattern on the substrate. Also, in recent years, electron beam lithography, where a concave/convex pattern is formed by drawing a pattern of nanometer size by irradiation with an electron beam instead of light, has been developed as a technology that is suited to the increased density of semiconductor elements and the increased capacity of information recording media. However, electron beam lithography has a problem in that it takes a long time to draw a pattern on a resist layer, making this method unsuited to mass production.

As a method of solving the above problem, “nano-imprinting lithography” (an imprinting method where a concave/convex pattern of nanometer size is formed: hereinafter referred to as the “imprinting method”) is disclosed in U.S. Pat. No. 5,772,905. In this method, a stamper on which a concave/convex pattern of nanometer size has been formed is pressed into a resin layer on a substrate to transfer the concave/convex form of the stamper to the resin layer and thereby form a concave/convex pattern of nanometer size on the substrate. In this imprinting method, as shown in FIG. 1A of U.S. Pat. No. 5,772,905, a stamper (mold) on whose transfer surface a concave/convex pattern of nanometer size (as one example, a minimum width of around 25 nm) is formed is manufactured. More specifically, after an electron beam lithography apparatus has drawn a desired pattern on a resin layer formed so as to cover a molding layer of silicon oxide or the like formed on the surface of a silicon substrate, the molding layer is etched by a reactive ion etching apparatus with the resin layer as a mask to form a concave/convex pattern with a plurality of convex parts (features) in the thickness of the molding layer. By doing so, a stamper is manufactured.

Next, as one example, polymethyl methacrylate (PMMA) is spin coated on the surface of a silicon substrate to form a resin layer (a thin film layer) with a thickness of around 55 nm. Next, after heating both the stamper and a multilayer structure composed of the substrate and the resin layer to around 200° C., as shown in FIG. 1B of the USP, the features of the stamper are pressed into the resin layer of the substrate with a pressure of 13.1 MPa (133.6 kgf/cm²). Next, the stamper is separated from the resin layer after the multilayer structure has been left to cool to room temperature in a state where the stamper is still pressed in (i.e., after a cooling process). By doing so, as shown in FIG. 1C of the USP, the features of the concave/convex pattern of the stamper are transferred to the resin layer to form a plurality of concave parts (regions), thereby forming a concave/convex pattern of nanometer size (in the resin layer) on the substrate.

### SUMMARY OF THE INVENTION

By investigating the conventional imprinting method described above, the present inventors discovered the following problem. That is, with this imprinting method, as shown in FIGS. 1A and 1B of the USP, a stamper formed so that the distances between the base surfaces of the regions in the concave/convex pattern and the tops of the respective features are uniform across the entire stamper (that is, a stamper formed so that the tops of the respective features are substantially flush) is pressed into the resin layer to form a concave/convex pattern on the substrate. In this case, positions where a plurality of features whose widths are comparatively narrow are formed and positions where a plurality of features whose widths are comparatively wide are formed are both present in the concave/convex pattern of the stamper. However, with the conventional imprinting method, since the concave/convex pattern is pressed into the resin layer with a substantially uniform pressing force across the entire stamper, it is difficult to sufficiently press the positions where the features with the comparatively wide widths are formed into the resin layer.

More specifically, as shown in FIG. 21, at the formation positions of convex parts 16 whose width W11 is comparatively narrow, the PMMA (the resin material forming the resin layer 20) can smoothly move inside the concave parts of the concave/convex pattern of the stamper 10 when the convex parts 16 are pressed in, so that it is possible to press the convex parts 16 sufficiently deeply into the resin layer 20. As a result, it is possible to form a concave/convex pattern on the substrate 18 with the thickness T11 of the residue between the tops of the convex parts 16 and the substrate 18 (i.e., the thickness of the base parts of the concave parts 24) being sufficiently thin. On the other hand, as shown in FIG. 22, at the formation positions of the convex parts whose width W13 is comparatively wide, the PMMA cannot smoothly move inside the concave parts of the concave/convex pattern when the convex parts 16 are pressed in, and therefore it is difficult to press the convex parts 16 sufficiently deeply into the resin layer 20. As a result, it is difficult to make the thickness T13 of the residue between the tops of the convex parts 16 and the substrate 18 sufficiently thin.

When an information recording medium, for example, is manufactured using the concave/convex pattern formed on the substrate 18, it is necessary to remove the residue at the base surfaces of the concave parts 24 of the concave/convex pattern from the substrate 18 by carrying out an etching process or the like. Accordingly, when a concave/convex pattern is formed on the substrate 18 by the conventional imprinting method, there is the problem that a long time is required to remove the residue with the thickness T13 at the positions where the convex parts 16 with the wide widths W13 have been pressed in. As described above, the thickness T11 of the residue at positions where the convex parts 16 with the narrow widths W11 have been pressed in is quite thin compared to the thickness T13. Accordingly, if the etching process is carried out for a sufficiently long time to definitely remove the residue with the thickness T13, the residue with the thickness T11 will be completely removed before the removal of the residue with the thickness T13 is complete. As a result, at positions where the residue with the thickness T11 is removed (the concave parts 24 with the width W11 on the substrate 18), the side walls of the concave parts 24 will be corroded by the gas that is continuously applied until the removal of the residue with the thickness T13 is complete, resulting in the widths of such concave parts 24 increasing. For this reason, when a concave/convex pattern is formed on the substrate 18 according to the conventional imprinting method, there is the problem that it is difficult to make the width of the concave parts 24 after the residue has been removed (i.e., after the etching process) the desired width.

The present invention was conceived in view of the problem described above and it is a principal object of the present invention to provide a stamper, an imprinting method, and a method of manufacturing an information recording medium that can precisely form a concave/convex pattern with concave parts of desired widths.

A stamper according to the present invention is a stamper for imprinting where a concave/convex pattern is formed with a plurality of convex parts of different widths protruding from a surface, wherein in the concave/convex pattern, the respective convex parts are formed so that a distance between a top of a convex part and a reference plane defined in a range between the surface and a rear surface of the stamper is longer for convex parts with wide widths than for convex parts with narrow widths. It should be noted that for the present invention, the expression “width of a convex part” refers to the distance between the side surfaces on opposite sides of the convex part. Also, the expression “the surface of the stamper” for the present invention refers to base surfaces of concave parts in the concave/convex pattern, that is, the surface on which the concave/convex pattern is formed. In this case, when the base surfaces of the respective concave parts in the concave/convex pattern are not flush, a base surface of one of the concave parts (as one example, a base surface, out of the base surfaces of the concave parts, that is closest to a rear surface of the stamper) is “the surface of the stamper” for the present invention. Also, the expression “a range between the surface and a rear surface of the stamper” for the present invention includes both the surface of the stamper and the rear surface of the stamper.

Also, an imprinting method according to the present invention transfers a concave/convex form of a concave/convex pattern of a stamper to a resin layer and includes a stamper pressing step of pressing the concave/convex pattern of the stamper described above into a resin layer formed by applying a resin material onto a surface of a substrate; and a stamper separating step of separating the stamper from the resin layer, the stamper separating step being executed after the stamper pressing step.

In addition, a method of manufacturing an information recording medium according to the present invention manufactures an information recording medium using the concave/convex pattern transferred to the resin layer by the imprinting method described above.

According to this stamper, imprinting method, and method of manufacturing an information recording medium, a concave/convex pattern is formed so that the respective convex parts are formed so that a distance between a top of a convex part and a reference plane (as one example, a base surface of any of the concave parts in the concave/convex pattern) is longer for convex parts with wide widths than for convex parts with narrow widths. This means that when a uniform pressing force is applied across the entire stamper during imprinting, it is possible to press the wide convex parts sufficiently deeply into the resin layer. Since it is possible to press both wide convex parts and narrow convex parts substantially uniformly and sufficiently into the resin layer, the thickness of the residue on the substrate can be made uniform across the entire region. Accordingly, since the time required to remove the residue is substantially equal across the entire region, it is possible to avoid corrosion of the side walls of the concave parts of the concave/convex pattern which would result in the widths of the concave parts changing to unintended widths. By doing so, it is possible to precisely form a concave/convex pattern with the correct pattern widths across the entire region. Also, by manufacturing an information recording medium using the concave/convex pattern that has the correct pattern widths, it becomes possible to manufacture an information recording medium that is not susceptible to recording and reproduction errors.

Also, the concave/convex pattern can be formed so as to include at least one convex part with a width of no greater than 150 nm and so that a ratio obtained by dividing a largest width of the convex parts by a smallest width of the convex parts is no less than 4. With this construction, when manufacturing a discrete-type magnetic recording medium, for example, it is possible to collectively form (to collectively transfer) a concave/convex pattern for forming concave parts of different widths, such as the grooves (concave parts) between data recording tracks and the concave parts in a servo pattern. In this case, even with a pattern that is susceptible to differences in penetration into a resin layer occurring during imprinting due to the differences in width (as one example, a concave/convex pattern for manufacturing the discrete track magnetic recording medium described above), the thickness of the residue can be made uniform across the entire region. The time required to remove the residue is therefore substantially equal across the entire region, and as a result, it is possible to avoid corrosion of the side surfaces of the concave parts in the concave/convex pattern which would change the widths of the concave parts to unintended widths. As a result, it is possible to precisely form the concave/convex pattern with the correct pattern widths across the entire region.

It should be noted that the disclosure of the present invention relates to a content of Japanese Patent Application 2004-172397 that was filed on 10 Jun. 2004 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a block diagram showing the construction of an imprinting apparatus;

FIG. 2 is a cross-sectional view showing the construction of a preform;

FIG. 3 is a cross-sectional view showing the construction of a stamper;

FIG. 4 is a cross-sectional view of a stamper where base surfaces of respective concave parts are not flush;

FIG. 5 is a cross-sectional view of a state where a resist layer has been formed on a disc-like substrate in a manufacturing process of the stamper;

FIG. 6 is a cross-sectional view of a state where an exposure pattern has been drawn (a latent image has been formed) by irradiating the resist layer in the state shown in FIG. 5 with an electron beam;

FIG. 7 is a cross-sectional view of a state where a concave/convex pattern has been formed on the disc-like substrate by developing the resist layer in the state shown in FIG. 6;

FIG. 8 is a cross-sectional view of a state where a nickel layer has been formed on the concave/convex pattern shown in FIG. 7;

FIG. 9 is a cross-sectional view of a state where a mask pattern has been formed on the disc-like substrate by removing the resist layer by soaking the disc-like substrate in the state shown in FIG. 8 in resist separating liquid;

FIG. 10 is a cross-sectional view of a state where the concave/convex pattern has been formed by carrying out an etching process on the disc-like substrate using the mask pattern;

FIG. 11 is a cross-sectional view of a state where an electrode film has been formed so as to cover the mask pattern shown in FIG. 10;

FIG. 12 is a cross-sectional view of a state where a nickel layer has been formed so as to cover the electrode film shown in FIG. 11;

FIG. 13 is a cross-sectional view of a state where the stamper has been positioned above the preform;

FIG. 14 is a cross-sectional view of a state where the stamper has been pressed into the resin layer of the preform;

FIG. 15 is a cross-sectional view of a vicinity of pressing positions of respective convex parts in the state shown in FIG. 14;

FIG. 16 is a cross-sectional view of a vicinity of pressing positions of respective convex parts in the state shown in FIG. 14;

FIG. 17 is a cross-sectional view of a state where a concave/convex pattern has been formed by separating the stamper from the preform in the state shown in FIG. 14;

FIG. 18 is a cross-sectional view of a state where a concave/convex pattern has been formed by etching the metal layer using the concave/convex pattern shown in FIG. 17;

FIG. 19 is a cross-sectional view of an information recording medium formed using the concave/convex pattern shown in FIG. 18;

FIG. 20 is a table showing the relationship between the widths of the convex parts in the concave/convex pattern of the stamper, the distances between a reference plane and the tops of the convex parts, the differences between the distances, and the thicknesses of the residue of the concave/convex pattern formed by pressing the stamper;

FIG. 21 is a cross-sectional view of a state where convex parts with a narrow width on a conventional stamper have been pressed into a resin layer; and

FIG. 22 is a cross-sectional view of a state where convex parts with a wide width on a conventional stamper have been pressed into a resin layer.

### DESCRIPTION OF THE PREFERRED EMBODIMENTS

Preferred embodiments of a stamper, an imprinting method, and a method of manufacturing an information recording medium will now be described with reference to the attached drawings.

First, the construction of an imprinting apparatus 1 that manufactures an information recording medium using a stamper according to the present invention will now be described with reference to the attached drawings.

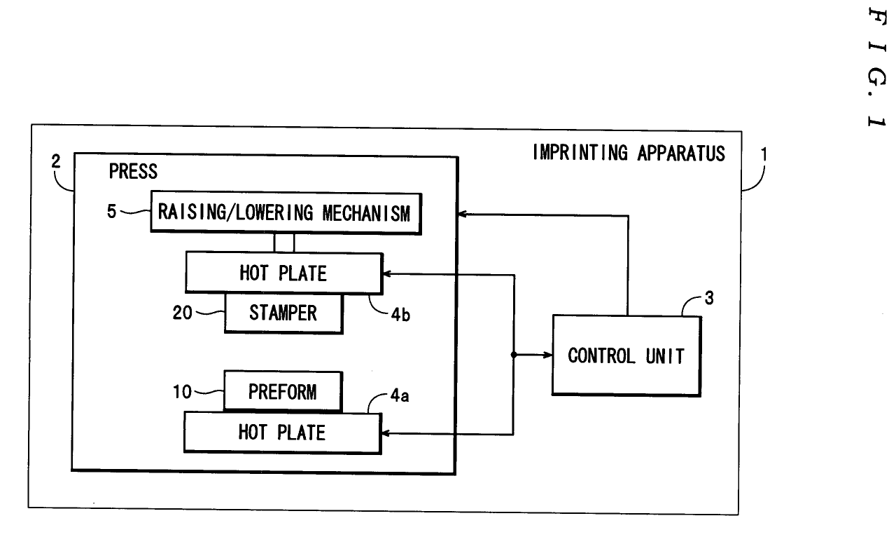

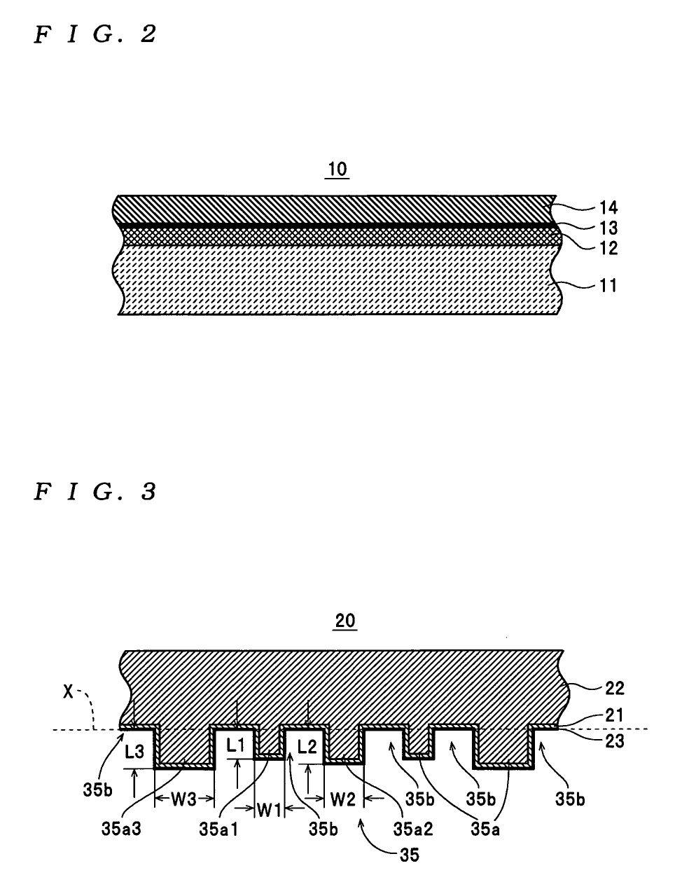

The imprinting apparatus 1 shown in FIG. 1 is a device that presses a stamper 20 (see FIG. 3) onto a preform 10 (see FIG. 2) using an imprinting method according to the present invention to form a concave/convex pattern 36 (see FIG. 17) when manufacturing an information recording medium 40 shown in FIG. 19, and includes a press 2 and a control unit 3. In this example, the information recording medium 40 is a discrete track magnetic recording medium on which a concave/convex pattern 38 is formed as shown in FIG. 19. The concave/convex pattern 38 is composed of a large number of concentric data recording tracks separated at a predetermined alignment pitch, a servo pattern for tracking control on the respective data recording tracks, and the like is formed. It should be noted that since the construction and the like of a discrete track magnetic recording medium are well known, no detailed description or illustration thereof will be given.

Also, as shown in FIG. 2, as one example the preform 10 is constructed by laminating a magnetic layer 12, a metal layer 13, and a resin layer 14 in that order on a disc-like substrate 11 formed in a disc shape from silicon, glass, ceramic, or the like. In reality, various functional layers such as a soft magnetic layer and an oriented layer are provided between the disc-like substrate 11 and the magnetic layer 12, but for ease of understanding the present invention, such layers will not be described or illustrated. It should be noted that in this example, the disc-like substrate 11, the magnetic layer 12 and the metal layer 13 together construct the “substrate” for the present invention. As examples, polystyrene resin, methacrylate resin (such as PMMA), polystyrene, phenol resin, novolac resin, and the like should preferably be used as the resin material that forms the resin layer 14 since a favorable concave/convex form is achieved for a concave/convex pattern 36 formed when the stamper 20 is separated as described later. In this example, the resin layer 14 is formed using novolac resin so that the thickness of the resin layer 14 is in a range of 40 nm to 100 nm, inclusive (as one example, 70 nm).

On the other hand, as shown in FIG. 3, the stamper (mold) 20 is formed in a disc shape with a thickness of around 300 μm by laminating an electrode film 21 and a nickel layer 22. The rear surface of the stamper 20 (the upper surface in FIG. 3) is formed flat and a concave/convex pattern 35 for forming the concave/convex pattern 36 in the resin layer 14 of the preform 10 is formed in the surface of the stamper 20 (this surface is the base surfaces of the concave parts 35b in the concave/convex pattern 35). In addition, as described later, to prevent the resin material from adhering to the stamper 20 when the stamper 20 is separated from the resin layer 14, an adhesive force reducing layer 23 is formed by coating the surface of the electrode film 21 (the surface of the concave/convex pattern 35) with a fluorochemical material, for example. In this case, the material that forms the adhesive force reducing layer 23 is not limited to a fluorochemical coating material, and any material that can reduce adhesion to the resin layer 14 may be used.

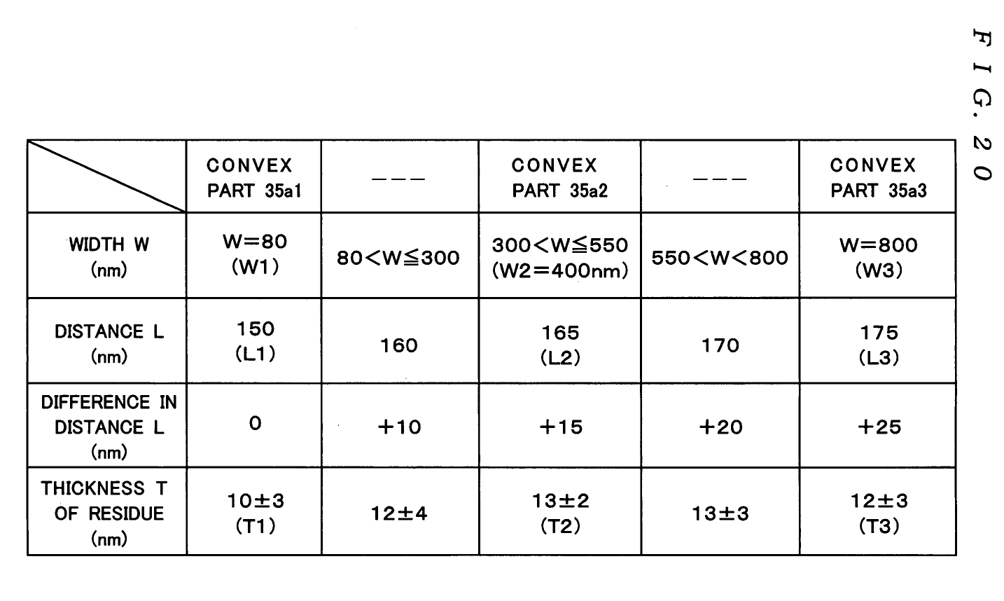

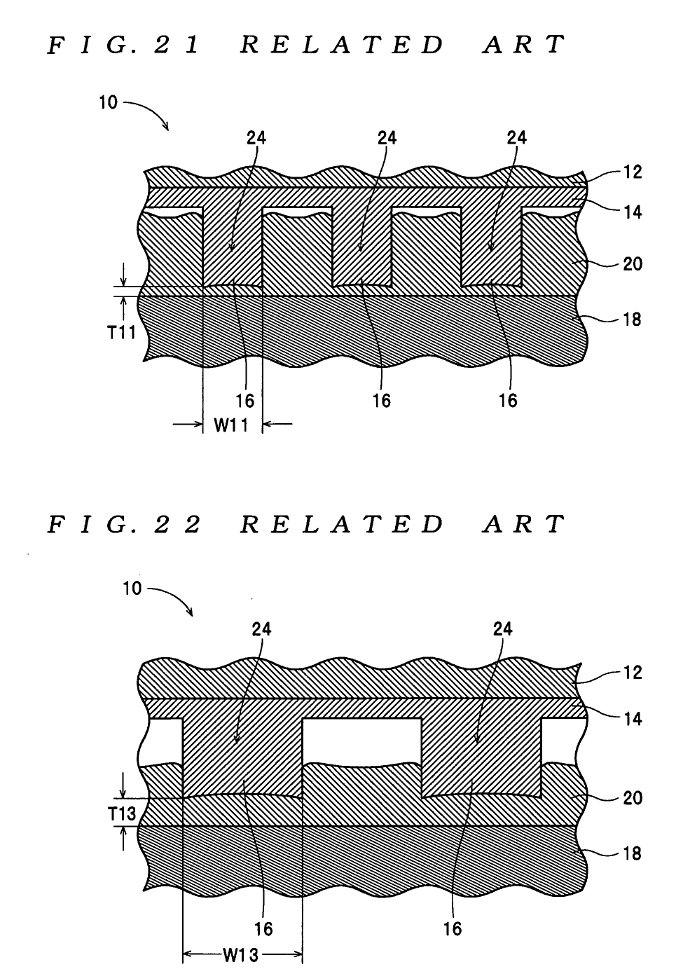

In this case, as shown in FIG. 3, the concave/convex pattern 35 of the stamper 20 is constructed by forming a plurality of types of convex parts 35a of different widths. More specifically, as one example, a convex part 35a1 forms a groove (a concave part) between data recording tracks of the information recording medium 40, and as shown in FIG. 20, is formed so that the width W1 thereof is around 80 nm, for example (one example of “a width of 150 nm or below” for the present invention). A convex part 35a2 forms a concave part in a servo pattern on the information recording medium 40 and is formed so that the width W2 thereof is around 400 nm, for example (one example of a width is greater than 300 nm but not greater than 550 nm). In addition, a convex part 35a3 forms another concave part in the servo pattern on the information recording medium 40 and is formed so that the width W3 thereof is around 800 nm, for example. Also, aside from the convex parts 35a1 to 35a3, a plurality of types of convex parts 35a (not shown) are formed in the concave/convex pattern 35, such as convex parts 35a whose width W is greater than 80 nm but no greater than 300 nm and convex parts 35a whose width W is greater than 550 nm but less than 800 nm. Accordingly, out of the widths W of the respective convex parts 35a in the concave/convex pattern 35, the ratio obtained by dividing the maximum width W (in this example, W3=800 nm) by the minimum width W (in this example, W1=80 nm) is around 10 (one example of “no less than 4” for the present invention).

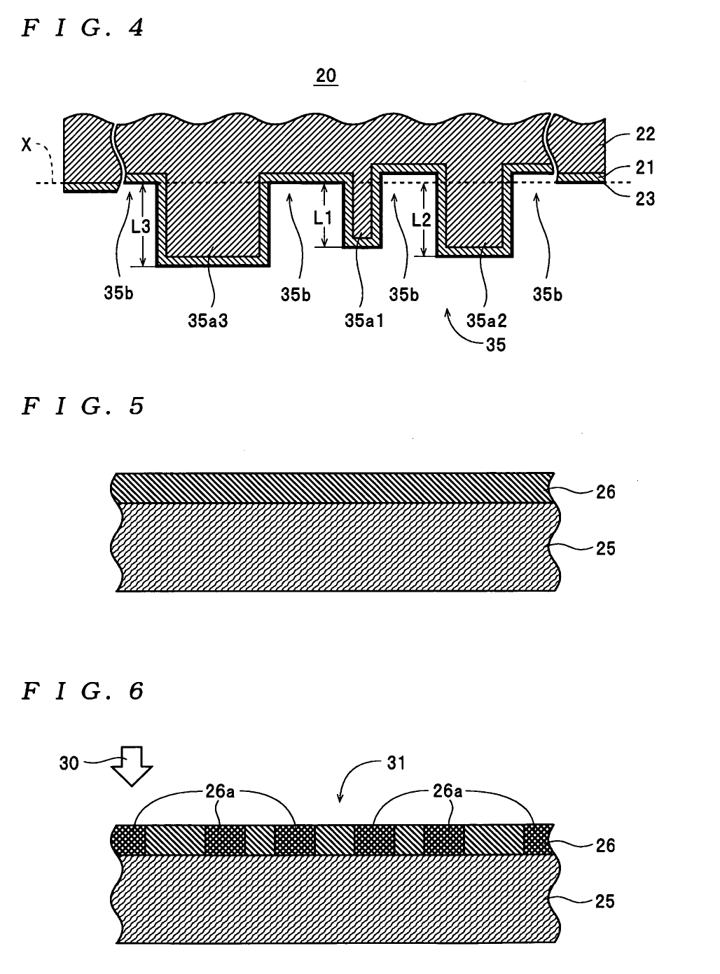

Also, as shown in FIG. 3, the base surfaces of the concave parts 35b between the respective convex parts 35a that compose the concave/convex pattern 35 are formed so as to be substantially flush with the surface of the stamper 20 on which the concave/convex pattern is formed (the “surface” for the present invention). It should be noted that in the present specification, the base surfaces of the concave surfaces 35b (that is, the surface on which the concave/convex pattern is formed) are described below as the “reference plane” (reference plane X) for the present invention. The position of the reference plane for the present invention is not limited to a position that matches the base surfaces of the concave parts 35b (a position that includes the base surfaces), and any chosen position between the rear surface of the stamper and the surface on which the concave/convex pattern is formed (that is, any position in a range of the thickness of the stamper) can be set as the reference plane X. Also, as shown in FIG. 4, according to this method of manufacturing, in some cases the base surfaces of the respective concave parts 35b are not flush, and in this case a plane including the base surface of any of the concave parts 35b (in the example in FIG. 4, the concave parts 35b formed on both sides of the convex part 35a3) can be set as the reference plane X.

Also, as shown in FIG. 3, the convex parts 35a in the concave/convex pattern 35 are formed so that the respective distances L between the reference plane X and the tops of the respective convex parts are set in accordance with the respective widths W of the convex parts. More specifically, the convex part 35a1 whose width W1 is around 80 nm is formed so that the distance L1 between the reference plane X and the top of the convex part 35a1 (that is, the protruding length of the convex part 35a1) is around 150 nm (see FIG. 20). The convex part 35a2 whose width W2 is around 400 nm is formed so that the distance L2 between the reference plane X and the top of the convex part 35a2 (that is, the protruding length of the convex part 35a2) is around 165 nm (see FIG. 20). Also, the convex part 35a3 whose width W3 is around 800 nm is formed so that the distance L3 between the reference plane X and the top of the convex part 35a3 (that is, the protruding length of the convex part 35a3) is around 175 nm (see FIG. 20). As a result, a difference of around 25 nm is provided between the distance L1 from the reference plane X to the top of the convex part 35a1 whose width W1 is 80 nm and the distance L3 from the reference plane X to the top of the convex part 35a3 whose width W3 is 800 nm. It should be noted that the difference between the distance L from the reference plane X to the top of the convex part 35a whose width W is smallest (in this example, the distance L1 between the reference plane X and the top of the convex part 35a1) and the distance L from the reference plane X to the top of the convex part 35a whose width W is largest (in this example, the distance L3 from the reference plane X to the top of the convex part 35a3) should preferably be 50 nm or below so that the respective convex parts 35a can be reliably pressed in when the stamper 20 is pressed into the resin layer 14 as described later.

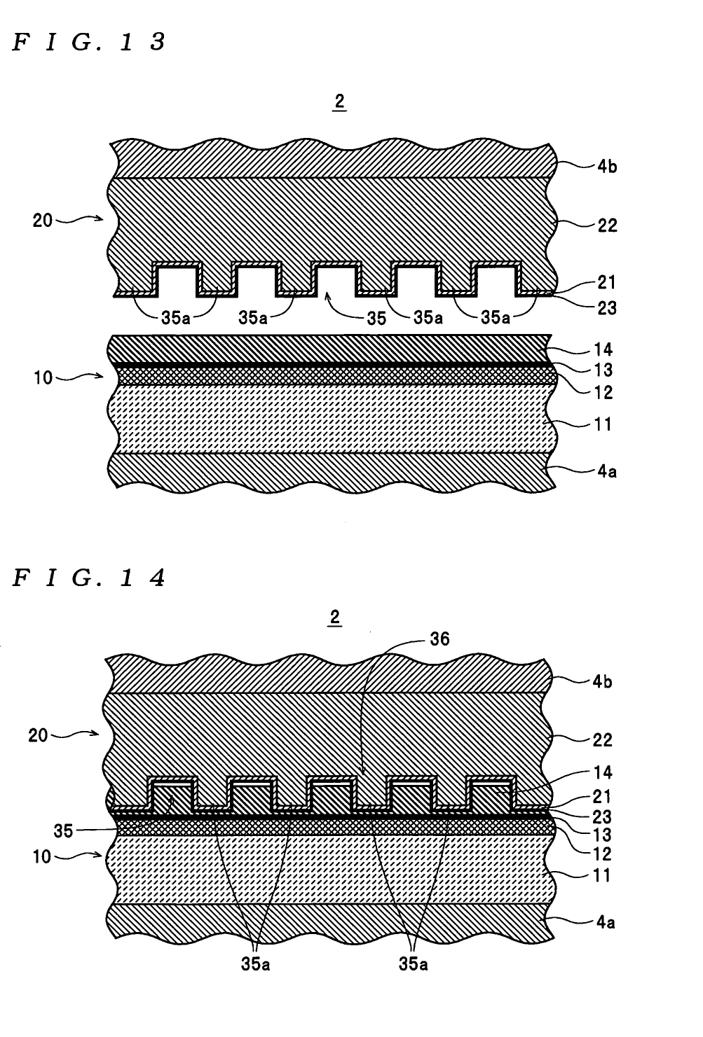

On the other hand, as shown in FIG. 1, the press 2 includes hot plates 4a, 4b and a raising/lowering mechanism 5. The hot plates 4a, 4b (hereinafter referred to as the “hot plates 4” when no distinction is required) heat the preform 10 and the stamper 20 under the control of the control unit 3. Also, as shown in FIG. 13, the hot plate 4a is constructed so as to be capable of holding the preform 10 in a state where the surface on which the resin layer 14 has been formed faces up, and the hot plate 4b is constructed so as to be capable of holding the stamper 20 in a state where the surface on which the concave/convex pattern 35 has been formed faces down. The raising/lowering mechanism 5 moves (lowers) the hot plate 4b toward the preform 10 held by the hot plate 4a, thereby pressing the stamper 20 held by the hot plate 4b into the resin layer 14 of the preform 10. Also, the raising/lowering mechanism 5 separates (raises) the hot plate 4b from the hot plate 4a, thereby separating the stamper 20 pressed into the resin layer 14 from the resin layer 14. The control unit 3 controls the hot plates 4 to heat both the preform 10 and the stamper 20 and controls the raising/lowering mechanism 5 to press the stamper 20 onto the preform 10 (the “stamper pressing step” for the present invention) and to separate the stamper 20 pressed into the preform 10 from the preform 10 (the “stamper separating step” for the present invention).

Next, the method of manufacturing the stamper 20 will be described with reference to the drawings.

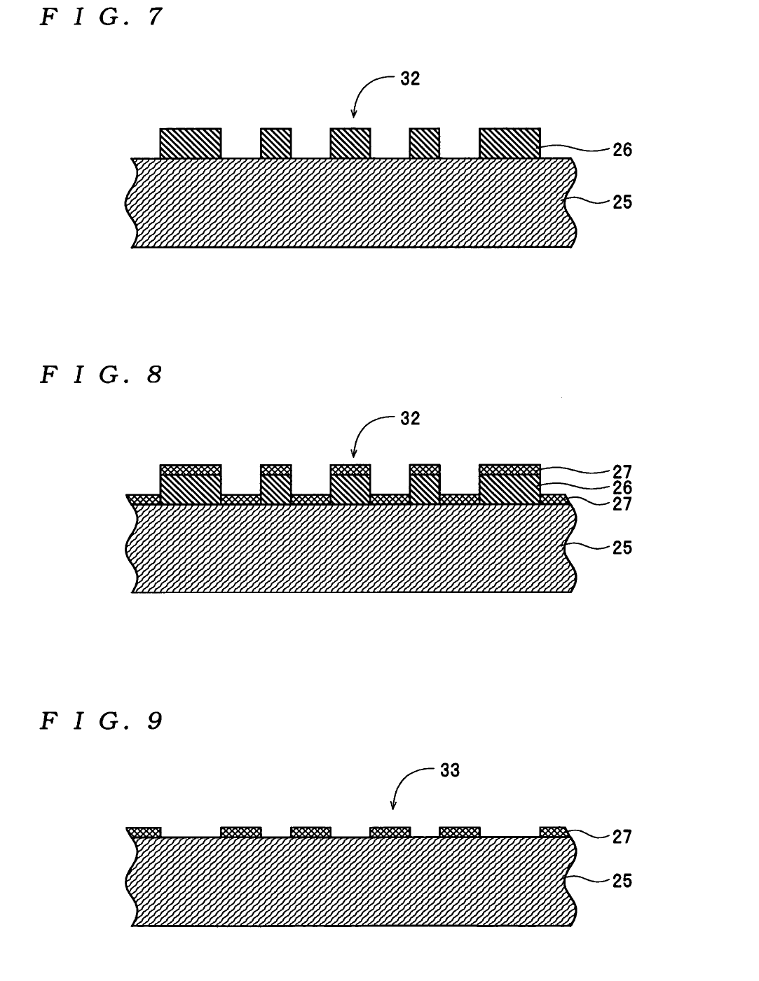

First, as shown in FIG. 5, by spin coating a resist (as one example “ZEP520A” made by ZEON CORPORATION of Japan) onto a disc-like substrate 25 that is made of silicon and has been polished so that its surface is flat, a resist layer 26 with a thickness of around 130 nm is formed on the surface of the disc-like substrate 25. It should be noted that the substrate used when manufacturing the stamper 20 is not limited to a silicon substrate, and various kinds of substrate, such as a glass substrate or a ceramic substrate, may be used. The resist used for forming the resist layer 26 is also not limited to the resist given above, and any freely chosen resist material can be used. Next, as shown in FIG. 6, an electron beam lithography apparatus irradiates the resist layer 26 with an electron beam 30 to draw a desired exposure pattern 31. Next, by developing the resist layer 26 in this state, parts where a latent image 26a has been formed in the resist layer 26 are removed. By doing so, as shown in FIG. 7, a concave/convex pattern 32 is formed on the disc-like substrate 25. Next, as shown in FIG. 8, by depositing nickel on the disc-like substrate 25 in this state, a nickel layer 27 with a thickness of around 50 nm is formed. After this, the disc-like substrate 25 in this state is soaked in a resist separating liquid to remove the resist layer 26, thereby forming a mask pattern 33 composed of the nickel layer 27 on the disc-like substrate 25 as shown in FIG. 9 (a lift-off process).

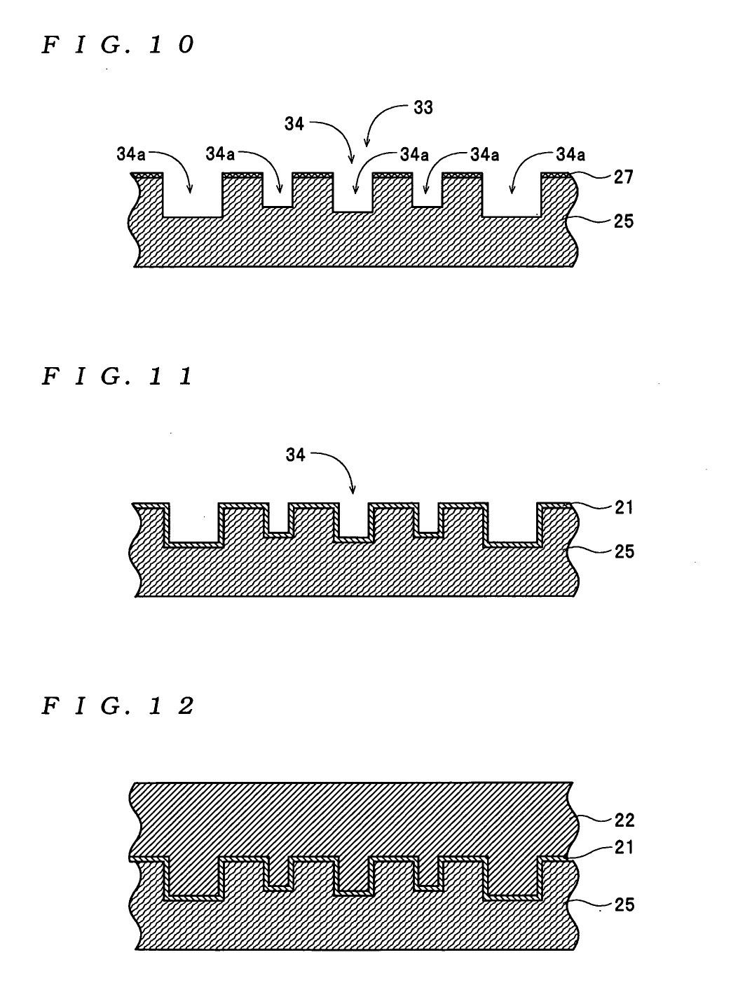

Next, by carrying out reactive ion etching using a mixture of CF₄ and O₂, for example, with the nickel layer 27 (a mask pattern 33) on the disc-like substrate 25 as a mask, the disc-like substrate 25 is etched as shown in FIG. 10 to form concave parts 34a and thereby form a concave/convex pattern 34. When doing so, the mixed proportions (the flow ratio) of the CF₄ and O₂, the pressure inside the processing apparatus, the amount of applied energy, the processing time, and the like are appropriately adjusted so that concave parts 34a formed at positions that are widely exposed by the mask pattern 33 (that is, positions where the convex parts 35a3 and the like of the stamper 20 will be formed) are more deeply etched than concave parts 34a formed at positions that are narrowly exposed by the mask pattern 33 (that is, positions where the convex parts 35a1 and the like of the stamper 20 will be formed). As a specific example, a 25-second etching process was carried out with the flow ratio of the CF₄ and O₂ etching gases set at 35:15 (flow rates of CF₄:35 sccm, O₂:15 sccm), the pressure inside the processing chamber set at 0.3 Pa, the microwave power set at RF1 kW, and the bias power applied to the disc-like substrate 25 set at RF200 W. As a result, as shown in FIG. 10, the concave/convex pattern 34 is formed so that the concave parts 34a with wide widths are deeper than the concave parts 34a with narrow widths.

Next, the disc-like substrate 25 in this state is soaked in aqua regia, for example, to remove the nickel layer 27 on the disc-like substrate 25. By doing so, a master original (not shown) is completed. Next, as shown in FIG. 11, after an electrode film 21 for electroforming has been formed along the concave/convex form of the concave/convex pattern 34 of the master original, electroforming is carried out using the electrode film 21 as an electrode to form the nickel layer 22 as shown in FIG. 12. After this, the multilayer structure composed of the electrode film 21 and the nickel layer 22 (the parts that form the stamper 20) is separated from the disc-like substrate 25. At this time, as one example, wet etching is carried out on the multilayer structure composed of the electrode film 21, the nickel layer 22, and the disc-like substrate 25 to remove the disc-like substrate 25 and thereby separate the multilayer structure composed of the electrode film 21 and the nickel layer 22. By doing so, the concave/convex pattern 34 of the master original is transferred to the electrode film 21 and the nickel layer 22 to form the concave/convex pattern 35 (see FIG. 13). After this, the rear surface of the nickel layer 22 is polished to make the rear surface flat and the surface of the electrode film 21 is coated with a fluorochemical material to form the adhesive force reducing layer 23. This completes the stamper 20 in which the concave/convex pattern 35 with the convex parts 35a of different widths W and different lengths L between the tops of the convex parts and the reference planes X is formed, as shown in FIG. 3.

Next, a process that forms a concave/convex pattern on the preform 10 using the stamper 20 described above in accordance with the imprinting method of the present invention will be described with reference to the drawings.

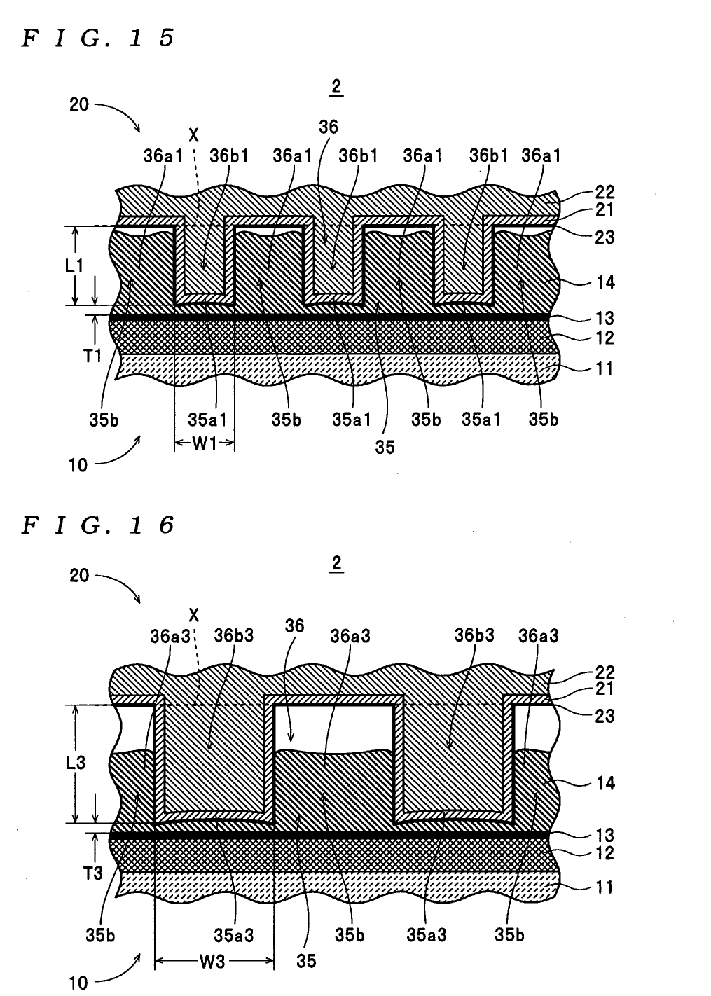

First, the preform 10 and the stamper 20 are set in the press 2. More specifically, as shown in FIG. 13, the preform 10 is attached to the hot plate 4a with the surface on which the resin layer 14 has been formed facing upward and the stamper 20 is attached to the hot plate 4b with the surface on which the concave/convex pattern 35 has been formed facing downward. It should be noted that as shown in FIG. 13 and in FIGS. 14 and 17 described later, for ease of understanding the method according to the present invention, the respective convex parts 35a in the concave/convex pattern 35 have been illustrated with the same widths and heights. After this, the control unit 3 controls the hot plates 4 so that the preform 10 and the stamper 20 are both heated. At this time, the hot plates 4 heat both the preform 10 and the stamper 20° C. to around 170° C., which is around 100° C. higher than the glass transition point (in this example, around 70° C.) of the novolac resin forming the resin layer 14. By doing so, the resin layer 14 softens and becomes easy to mold. Here, heating to a temperature in a range of 70° C. to 120° C., inclusive, higher than the glass transition point of the resin material is preferable, with heating to at least 100° C. higher than the glass transition point being more preferable. By doing so, as described later, it becomes easy to press the stamper 20 into the resin layer 14.

Next, the control unit 3 controls the raising/lowering mechanism 5 to lower the hot plate 4b toward the hot plate 4a and thereby press the concave/convex pattern 35 of the stamper 20 into the resin layer 14 of the preform 10 on the hot plate 4a (the “stamper pressing step” for the present invention). At this time, in accordance with the control of the control unit 3, as one example, the raising/lowering mechanism 5 maintains a state where a load of 34 kN is applied across the entire stamper 20 for five minutes. In accordance with the control of the control unit 3, the hot plates 4 continuously carry out a heating process so that the temperatures of the preform 10 and the stamper 20 do not fall while the stamper 20 is being pressed on the preform 10 by the raising/lowering mechanism 5. It should be noted that during the heating process, the temperature should preferably be maintained in a range of 170° C.±1° C. (as one example, a temperature where the change is in a range of ±0.2° C.). By doing so, the concave/convex pattern 35 of the stamper 20 is transferred to the resin layer 14 to form the concave/convex pattern 36. At this time, the imprinting apparatus 1 uses the stamper 20 in which the concave/convex pattern 35, where the distance from the reference plane X to the top of a convex part is greater for convex parts 35a with wide widths W than for the convex parts 35a with narrow widths W, is formed. Accordingly, when a uniform pressure is applied across the entire stamper 20, the convex parts 35a with the wide widths W are pressed deeply into the resin layer 14 in the same way as the convex parts 35a with the narrow widths W. As a result, the respective convex parts 35a with different widths W are pressed into the resin layer 14 substantially uniformly.

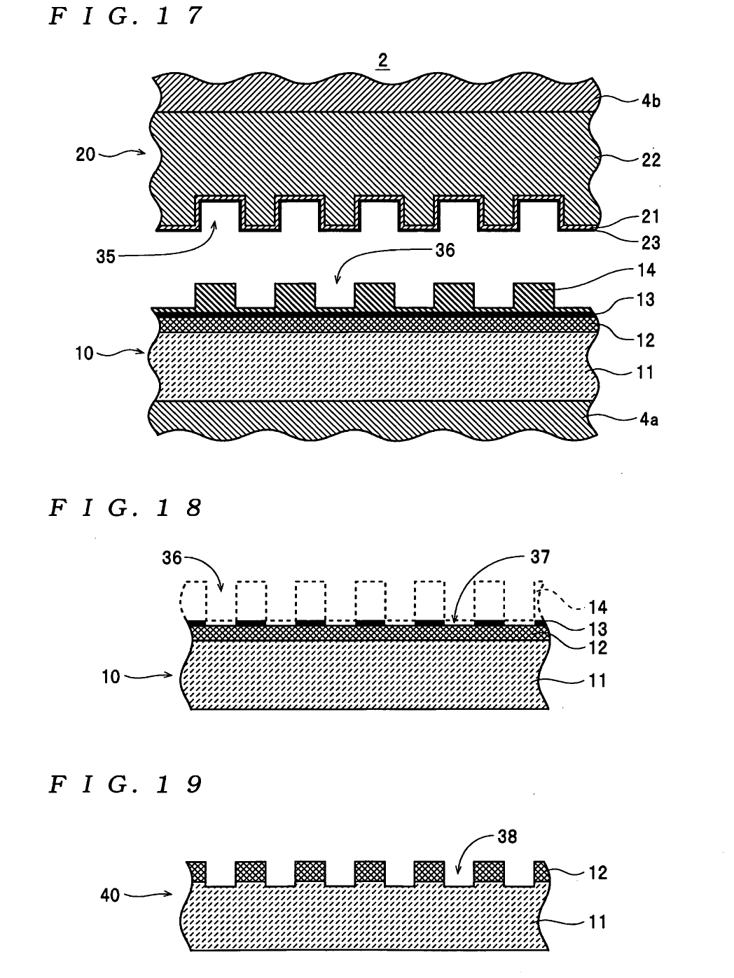

More specifically, as shown in FIG. 15, at the positions where the convex parts 35a1 whose width W1 is around 80 nm are formed, the resin layer 14 at the positions where the convex parts 35a1 are pressed in moves smoothly toward the concave parts 35b of the stamper 20, resulting in the convex parts 35a1 being pressed sufficiently deeply into the resin layer 14 of the preform 10. Accordingly, the thickness T1 of residue (the resin layer 14 between the base surfaces of the concave parts 36b1 and the surface of the metal layer 13) at positions where the convex parts 35a1 are pressed in is extremely thin at 10 nm±3 nm (see FIG. 20). On the other hand, as shown in FIG. 16, at the positions where the convex parts 35a3 whose width W1 is around 80 nm are formed, at 125 nm the distance L3 between the reference plane X and the tops of the convex parts 35a3 is around 25 nm longer than the distance L1 between the reference plane X and the tops of the convex parts 35a1, so that the wide concave parts 35a3 that are difficult to press into the resin layer 14 are pressed sufficiently deeply into the resin layer 14. Accordingly, the thickness T3 of the residue (the resin layer 14 between the base surfaces of the concave parts 36b3 and the surface of the metal layer 13) at positions where the convex parts 35a3 have been pressed in is extremely thin at around 12 nm±3 nm (see FIG. 20).

Also, as shown in FIG. 20, on the stamper 20, the convex parts 35a whose width W is greater than 80 nm but is not greater than 300 nm, the convex parts 35a whose width W is greater than 300 nm but is not greater than 550 nm (as one example, the convex parts 35a2 whose width W2 is around 400 nm), and the convex parts 35a whose width W is greater than 550 nm but less than 800 nm are formed so that the distance L between the reference plane X and the tops of the convex parts increases as the width W of the convex parts increases (as the width that is difficult to press into the resin layer 14 increases). This means that the convex parts 35a of the respective widths can be sufficiently and substantially equally pressed into the resin layer 14. Accordingly, the thicknesses T of the residue at the pressing positions of the convex parts 35a of the various widths are extremely thin at 12 nm±4 nm to 13 nm±3 nm, with the thicknesses T1, T3 of the residue at the pressing positions of the convex parts 35a1, 35a3 being substantially equal. By doing so, the thickness T of the residue in the concave parts 36b formed at the positions where the convex parts 35a whose widths W vary from 80 nm to 800 nm have been pressed in is substantially equal across the entire metal layer 13.

Next, while controlling the hot plates 4 to have the heating process continued (to keep the temperature in a range of 170° C.±1° C.), as shown in FIG. 17, the control unit 3 controls the raising/lowering mechanism 5 to raise the hot plate 4b and thereby separate the stamper 20 from the preform 10 (the resin layer 14) (the “stamper separating step” for the present invention). By doing so, the concave/convex form of the concave/convex pattern 35 of the stamper 20 is transferred to the resin layer 14 of the preform 10, thereby forming the concave/convex pattern 36 on the metal layer 13. This completes the imprinting process.

Next, the process for manufacturing the information recording medium 40 according to the method of manufacturing an information recording medium of the present invention will be described with reference to the drawings.

First, the resin material (residue) remaining on the base surfaces of the concave/convex pattern 36 in the resin layer 14 is removed by an oxygen plasma process. When doing so, since the thickness T1 to T3 on the metal layer 13 is extremely thin and substantially even at around 7 nm to 16 nm (see FIG. 20), the removal of the residue across the entire magnetic layer 12 can be completed by carrying out an etching process for a comparatively short time. Accordingly, the widths of the concave parts do not change to unintended widths (that is, the side surfaces of the concave parts are not greatly eroded) when the residue is removed. Next, an etching process that uses a metal-etching gas is carried out with the concave/convex pattern 36 (the convex parts) as a mask. At this time, as shown in FIG. 18, the parts of the metal layer 13 at the base surfaces of the concave parts of the concave/convex pattern 36 are removed so that a concave/convex pattern 37 composed of the metal material is formed on the magnetic layer 12. Next, an etching process is carried out using a gas for etching the magnetic material, with the concave/convex pattern 37 (the remaining metal layer 13) being used as a mask. By doing so, parts of the magnetic layer 12 that are exposed by the concave/convex pattern 37 are removed.

Next, the metal layer 13 remaining on the magnetic layer 12 is removed by carrying out an etching process using a metal-etching gas. By doing so, as shown in FIG. 19, a concave/convex pattern 38, where grooves with the same pitch as the arrangement pitch of the respective convex parts in the concave/convex pattern 36 to which the concave/convex form of the stamper 20 has been transferred, is formed in the track formation region of the magnetic layer 12. In this case, the magnetic layers 12 that are separated by one another by grooves, that is, discrete tracks are formed. Next, a surface treatment process is carried out. During this surface treatment process, after the grooves have first been filled with silicon oxide (not shown), the surface is polished flat using a CMP (Chemical Mechanical Polishing) apparatus. Next, a protective film is formed of DLC (Diamond-Like Carbon), for example, on the polished surface and finally a lubricant is applied. By doing so, the information recording medium 40 is completed. In this case, since the information recording medium 40 is manufactured using the concave/convex pattern 36 whose pattern widths are formed at the desired widths, the concave/convex pattern 38 (the data recording tracks, servo pattern, and the like) formed using the concave/convex pattern 36 (the concave/convex pattern 37) is also formed with the desired widths. As a result, the occurrence of recording errors and reproduction errors is avoided.

In this way, according to the imprinting method that uses the stamper 20 (i.e., the method of manufacturing the information recording medium 40), by forming the concave/convex pattern 35 in which the convex parts 35a have been formed so that the distance L between the reference plane X (in this example, a plane including the base surfaces of the concave parts 35b) and the tops of the convex parts is longer for the convex parts 35a whose width W is wide (for example, the convex parts 35a3) than for the convex parts 35a whose width W is narrow (for example, the convex parts 35a1), when a uniform pressing force is applied across the entire stamper 20 during imprinting, the wide convex parts 35a that are difficult to press into the resin layer 14 (for example, the convex parts 35a3) can be pressed into the resin layer 14 sufficiently deeply. For this reason, both the convex parts 35a whose width W is narrow (for example, the convex parts 35a1) and the convex parts 35a whose width W is wide (for example, the convex parts 35a3) can be sufficiently and substantially equally pressed into the resin layer 14, and as a result it is possible to make the thickness T of the residue on the metal layer 13 uniform across the entire region. Accordingly, since the time required to remove the residue is substantially equal across the entire region, it is possible to avoid corrosion of the side walls of the concave parts 36b of the concave/convex pattern 36 which would result in the widths of the concave parts 36b changing to unintended widths. By doing so, it is possible to precisely form the concave/convex pattern 36 with the correct pattern widths across the entire region. Also, by manufacturing the information recording medium 40 using the concave/convex pattern 36 that has the correct pattern widths, it becomes possible to manufacture an information recording medium 40 that is not susceptible to recording and reproduction errors.

Also, by forming the concave/convex pattern 35 of the stamper 20 so as to include at least one convex part 35a (for example, the convex part 35a1) whose width W is no greater than 150 nm and so that the ratio obtained by dividing the largest width W by the smallest width W of the convex parts 35a is no less than 4 (in this example, around 10), when manufacturing a discrete-type magnetic recording medium, it is possible to collectively form (to collectively transfer) a concave/convex pattern for forming concave parts of different widths, such as the grooves (concave parts) between data recording tracks and the concave parts in a servo pattern. In this case, even with a pattern that is susceptible to differences in penetration into the resin layer 14 occurring during imprinting due to the differences in width (as one example, a concave/convex pattern for manufacturing the discrete track magnetic recording medium described above), the thickness of the residue can be made uniform across the entire region. The time required to remove the residue is therefore substantially equal across the entire region, and as a result, it is possible to avoid corrosion of the side surfaces of the concave parts 36b in the concave/convex pattern 36 which would change the widths of the concave parts 36b to unintended widths. As a result, it is possible to precisely form the concave/convex pattern 36 with the correct pattern widths across the entire region.

It should be noted that the present invention is not limited to the construction and method described above. For example, although in the method of manufacturing the stamper 20 described above, the stamper 20 is manufactured by forming the electrode film 21 and the nickel layer 22 so as to cover the concave/convex pattern 34 formed by etching the disc-like substrate 25 using the nickel layer 27 (the mask pattern 33) as a mask, the method of manufacturing a stamper according to the present invention is not limited to this. As one example, it is possible to manufacture the stamper 20 by forming a concave/convex pattern (not shown) by forming concave parts of different depths in the resist layer 26 on the disc-like substrate 25 and then forming the electrode film 21 and the nickel layer 22 so as to cover such concave/convex pattern. It is also possible to manufacture the stamper according to the present invention by using a stamper, which has been manufactured by transferring the concave/convex form of the stamper 20 described above to a stamper forming material, as a master stamper and transferring the concave/convex form of the master stamper to another stamper forming material, that is, by transferring the concave/convex form of the stamper 20 an even number of times.

In addition, in the imprinting method that uses the imprinting apparatus 1 (the method of manufacturing the information recording medium 40) described above, the heating process is continuously carried out on both the preform 10 and the stamper 20 during a period from before commencement of the pressing process of the stamper 20 onto the preform 10 until completion of the separation process for the stamper 20, but the present invention is not limited to this. As one example, it is also possible to carry out a process where the heating process for the preform 10 and the stamper 20 ends after the stamper 20 has been sufficiently pressed into the preform 10 and the stamper 20 is then separated. In this case, during the pressing of the stamper 20 into the preform 10 and during the separation of the stamper 20, the temperature of both the preform 10 and the stamper 20 should preferably be prevented from falling rapidly, with it being even more preferable to prevent the temperatures from falling below the glass transition point of the resin material composing the resin layer 14. By doing so, differences in the amount of contraction between the preform 10 (the disc-like substrate 11) and the stamper 20 before separation has been completed can be avoided, and as a result, it is possible to form a concave/convex pattern with no deformation or faults or with only minor deformation and extremely few faults.

In addition, the concave/convex pattern formed according to the imprinting method of the present invention is not limited to being used in the manufacturing of a discrete track information recording medium, and the concave/convex pattern may be used when manufacturing a patterned medium with a pattern aside from a track pattern or when manufacturing products (for example, electronic components) aside from information recording media.

1. A stamper for imprinting where a concave/convex pattern is formed with a plurality of convex parts of different widths protruding from a surface,
wherein in the concave/convex pattern, the respective convex parts are formed so that a distance between a top of a convex part and a reference plane defined in a range between the surface and a rear surface of the stamper is longer for convex parts with wide widths than for convex parts with narrow widths.

2. A stamper according to claim 1,
wherein the concave/convex pattern includes at least one convex part with a width of no greater than 150 nm and is formed so that a ratio obtained by dividing a largest width of the convex parts by a smallest width of the convex parts is no less than 4.

3. An imprinting method that transfers a concave/convex form of a concave/convex pattern of a stamper to a resin layer, comprising:
a stamper pressing step of pressing the concave/convex pattern of a stamper according to claim 1 into a resin layer formed by applying a resin material onto a surface of a substrate; and
a stamper separating step of separating the stamper from the resin layer, the stamper separating step being executed after the stamper pressing step.

4. An imprinting method that transfers a concave/convex form of a concave/convex pattern of a stamper to a resin layer, comprising:
a stamper pressing step of pressing the concave/convex pattern of a stamper according to claim 2 into a resin layer formed by applying a resin material onto a surface of a substrate; and
a stamper separating step of separating the stamper from the resin layer, the stamper separating step being executed after the stamper pressing step.

5. A method of manufacturing an information recording medium that manufactures an information recording medium using the concave/convex pattern transferred to the resin layer by the imprinting method according to claim 3.

6. A method of manufacturing an information recording medium that manufactures an information recording medium using the concave/convex pattern transferred to the resin layer by the imprinting method according to claim 4.
